(19) United States
(12) Patent Application Publication
(10) Pub. No.: US 2007/0183621 A1
(43) Pub. Date: Aug. 9, 2007

(54) Diaphragm for tweeter

(76) Inventor: Chui-Che Chen, Taichung (TW)

Correspondence Address: TROXELL LAW OFFICE PLLC, SUITE 1404, 5205 LEESBURG PIKE, FALLS CHURCH, VA, 22041, US

(21) Appl. No.: 11/346,352

(22) Filed: Feb. 3, 2006

(51) Int. Cl. H04R 1/00; H04R 9/06; H04R 7/00; H04R 11/02

(52) U.S. Cl. 381/428; 381/426; 381/423; 181/169

(57) ABSTRACT

A diaphragm for tweeter is made of loosened and arbitrarily oriented carbon fiber pieces, or a mixture of such loosened and arbitrarily oriented carbon fiber pieces and a predetermined amount of organic or inorganic fibers, which are processed to form a paper-like or non-woven fabric-like thin sheet having a final thickness from about 0.02 mm to about 0.15 mm. The diaphragm so produced has increased structural strength to resist humidity and insect-biting, and a sufficient rigidity and very small thickness to produce clear and soft sound quality.

### FIELD OF THE INVENTION

The present invention relates to a diaphragm for tweeter, and more particularly to a diaphragm for tweeter made of loosened and arbitrarily oriented carbon fiber pieces, or a mixture of such loosened and arbitrarily oriented carbon fiber pieces and a predetermined amount of organic or inorganic fibers to have very small thickness but sufficient structural rigidity and produce clear and soft sound quality.

### BACKGROUND OF THE INVENTION

There was an attempt of manufacturing a diaphragm for tweeter using paper as a raw material. However, the research and development of paper-made diaphragm for tweeter terminated eventually in view that the produced paper diaphragm would not have sufficient structural strength to resist humidity and insect biting. Later, diaphragm for tweeter using a metal material, such as magnesium, aluminum, titanium, or beryllium, has been developed. While the metal-made diaphragm for tweeter has high rigidity to resist humidity and insect biting, it produces while vibrating a sound that is too loud and sharp to be accepted. There are also diaphragms for tweeter made of very fine fabrics woven from nylon filaments, cotton threads, or silk. While the fabric-made diaphragms have sufficient structural strength to resist humidity and insect biting, they are not rigid enough to produce a sound with ideal clarity when being vibrated. There are still other diaphragms for tweeter made of a plastic or a rubber material. The plastic or rubber diaphragms also fail to produce perfect sound quality. Therefore, there is a need for developing a diaphragm for tweeter that has good structural strength and rigidity and produces perfect sound quality.

### SUMMARY OF THE INVENTION

A primary object of the present invention is to provide a diaphragm for tweeter that has a structure softer than that of a diaphragm made of a metal material, but more rigid than that of a diaphragm made of a fabric woven from nylon, cotton, or silk to produce clear and soft sound quality, and has a strength higher than paper to resist-humidity and insect biting.

To achieve the above and other objects, the diaphragm for tweeter according to the present invention is made of loosened and arbitrarily oriented carbon fiber pieces alone, or a mixture of such loosened and arbitrarily oriented carbon fiber pieces and a predetermined amount of organic or inorganic fibers, which are processed to form a paper-like or non-woven fabric-like thin sheet having a very small final thickness from about 0.02 mm to about 0.15 mm.

The diaphragm produced with the loosened and arbitrarily oriented carbon fiber pieces or a mixture of such carbon fiber pieces with organic or inorganic fibers has increased structural strength to resist humidity and insect-biting, and a sufficient rigidity and small thickness best to produce clear and soft sound quality.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a flowchart showing the steps of manufacturing the diaphragm for tweeter according to the present invention; and

FIG. 2 is a structural diagram of a diaphragm for tweeter according to an embodiment of the present invention.

### DETAILED DESCRIPTION OF THE PREFERRED EMBODIMENTS

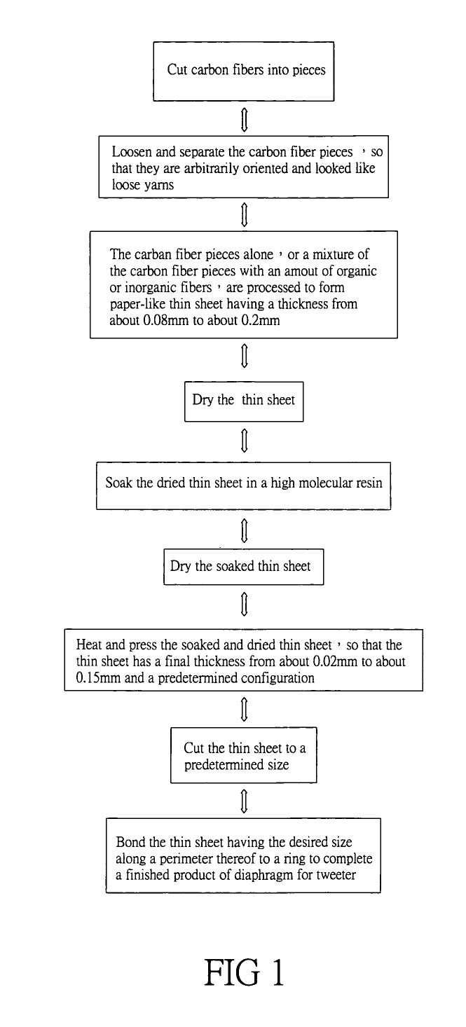

Please refer to FIG. 1 that is a flowchart showing the steps of manufacturing a diaphragm for tweeter according to the present invention. First, carbon fibers are cut to pieces, which are then loosened and separated to look like arbitrarily oriented loose yarns. The diaphragm for tweeter may be manufactured using the loosened and arbitrarily oriented carbon fiber pieces alone, or a mixture of the loosened carbon fiber pieces and organic or inorganic fibers as a raw material thereof. In one example, the mixture may contain 50% of carbon fiber pieces and 50% of organic or inorganic fibers. In another example, the mixture may contain 80% of carbon fiber pieces and 20% of organic or inorganic fibers. The raw material is processed to form a paper-like or non-woven fabric-like thin sheet having a thickness from about 0.08 mm to about 0.2 mm. Thereafter, the thin sheet is dried before being soaked in a high molecular resin. The soaked thin sheet is then dried again and heated and pressed to have an even reduced thickness from about 0.02 mm to about 0.15 mm and a desired configuration. The thin sheet having the desired configuration is then cut into a predetermined size for forming a finished product of diaphragm for tweeter.

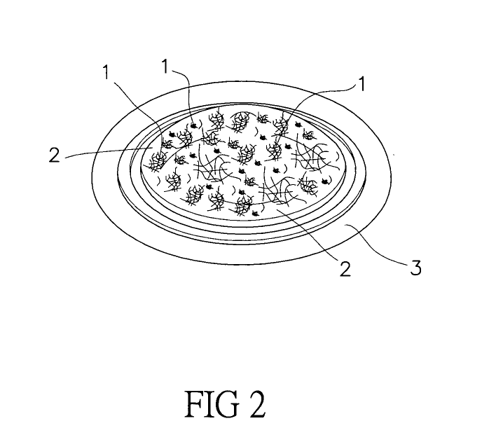

Please refer to FIG. 2, in which a diaphragm for tweeter according to an embodiment of the present invention is shown. In the illustrated embodiment, the diaphragm is made of a raw material containing 50% of carbon fibers 1. To manufacture the diaphragm, first cut the carbon fibers 1 into pieces, which are then loosened and separated to look like arbitrarily oriented loose yarns. Thereafter, an-amount of organic fibers 2, such as 50% of paper fibers, are mixed with the loosened carbon fiber pieces 1. In another embodiment of the present invention, it is also possible to mix an amount of inorganic fibers, such as 50% of fiberglass with the carbon fiber pieces 1. The mixture is processed to form a paper-like or non-woven fabric-like thin sheet having a thickness from about 0.08 mm to about 0.2 mm. Thereafter, the thin sheet is dried before being soaked in a high molecular resin. The soaked thin sheet is then dried again and heated and pressed to have an even reduced thickness from about 0.02 mm to about 0.15 mm and a desired configuration, such as a hemispherical or a conical shape, for differently shaped tweeters. The final thin sheet having the desired configuration is then cut into a predetermined size for bonding along a perimeter thereof to a ring 3 to form a thin and light-weight diaphragm with suitable rigidity, which may be used to complete a tweeter to produce clear and soft sound quality.

What is claimed is:

1. A diaphragm for tweeter, comprising a plurality of loosened and arbitrarily oriented carbon fiber pieces, which are obtained by cutting carbon fibers into pieces, and then loosening and separating said carbon fiber pieces, so that said carbon fiber pieces looked like loose yarns; and said loosened and arbitrarily oriented carbon fiber pieces being processed to form a paper-like thin sheet, which is subjected to further processing to reduce a thickness thereof and form a predetermined shape.

2. The diaphragm for tweeter as claimed in claim 1, further comprising a predetermined amount of organic fibers mixed with said loosened and arbitrarily oriented carbon fiber pieces; and a mixture of said loosened and arbitrarily oriented carbon fiber pieces and said organic fibers is processed to form a paper-like thin sheet, which is subjected to further processing to reduce a thickness thereof and form a predetermined shape.

3. The diaphragm for tweeter as claimed in claim 1, further comprising a predetermined amount of inorganic fibers mixed with said loosened and arbitrarily oriented carbon fiber pieces; and a mixture of said loosened and arbitrarily oriented carbon fiber pieces and said inorganic fibers is processed to form a paper-like thin sheet, which is subjected to further processing to reduce a thickness thereof and form a predetermined shape.

4. The diaphragm for tweeter as claimed in claim 1, wherein said diaphragm in the form of said thin sheet has a final thickness within a range from about 0.02 mm to about 0.15 mm.

5. The diaphragm for tweeter as claimed in claim 2, wherein said diaphragm in the form of said thin sheet has a final thickness within a range from about 0.02 mm to about 0.15 mm.

6. The diaphragm for tweeter as claimed in claim 3, wherein said diaphragm in the form of said thin sheet has a final thickness within a range from about 0.02 mm to about 0.15 mm.
